(19) United States
(12) Patent Application Publication
(10) Pub. No.: US 2026/0141120 A1
(43) Pub. Date: May 21, 2026

(54) Entropy Integrity and Forensics Framework (EIF) for Large Language Model Security

(71) Applicant: José Manuel dos Santos Carrascozinho Bonito Viegas, Lisbon (PT)

(72) Inventor: José Manuel dos Santos Carrascozinho Bonito Viegas, Lisbon (PT)

(21) Appl. No.: 19/446,666

(22) Filed: Jan. 12, 2026

(51) Int. Cl. G06F 21/64

(52) U.S. Cl. CPC G06F 21/64

(57) ABSTRACT

A computer-implemented system for monitoring entropy integrity and detecting sampling manipulation in Large Language Model (LLM) systems. The Entropy Integrity and Forensics Framework (EIF) operates as a supervisory layer positioned between an entropy source and an LLM sampling mechanism, intercepting entropy values BEFORE token selection. Nine integrated modules provide: ESIM for statistical validation via Entropy of Collapse Paths; SDF for distribution forensics via KL-divergence and Fisher-Rao distance; CICD for cross-instance correlation via CCPI and topological analysis; TEF for temporal forensics with cryptographic audit trails; ICL for intent classification; optional QRNG-A for Fubini-Study baseline comparison; CTM for reasoning pathway monitoring; SPI for parameter integrity; and APL for attribution. The framework generates Entropy Injection Signature (EIS) alerts and executes policy-gated corrective actions when integrity thresholds are exceeded. In one or more embodiments, low latency may enable real-time monitoring. Fail-closed modes support high-assurance deployments.

### CROSS-REFERENCE TO RELATED APPLICATIONS

This application claims priority under 35 U.S.C. § 119 (e) to U.S. Provisional Patent Application No. 63/957,491, filed Jan. 9, 2026, entitled “Entropy Integrity and Forensics Framework (EIF) for Large Language Model Security,” the entire contents of which are incorporated herein by reference.

This application is related to U.S. patent application Ser. No. 19/231,235, filed Jun. 6, 2025, entitled “Quantum Semantic Prediction and Anticipatory Response Generation Framework” (hereinafter “QSP-EF”), which is incorporated herein by reference for disclosure of shared semantic deviation taxonomy, interfaces, and integration embodiments. No claim of priority under 35 U.S.C. § 120 is made to the related application.

This application is also related to the following provisional applications: U.S. Provisional Application No. 63/865,604 (PHCI—Predictive Heisenberg Contamination Interface), filed Aug. 18, 2025; and U.S. Provisional Application No. 63/869,139 (CSL—Cognitive Security Layer), filed Aug. 23, 2025; both of which are incorporated herein by reference.

### STATEMENT REGARDING FEDERALLY SPONSORED RESEARCH

Not applicable.

### INCORPORATION BY REFERENCE

The disclosures of the patents, published patent applications, and other documents expressly identified in this specification are incorporated herein by reference in their entirety to the extent that such disclosures are consistent with the present application and are not inconsistent with the express teachings herein. References are cited for completeness and context. Citation or incorporation by reference of any document is not an admission that the cited document constitutes prior art or that any feature disclosed therein is material to patentability.

### 1. TECHNICAL FIELD

The present invention relates generally to artificial intelligence security systems, and more particularly to systems and methods for monitoring entropy integrity, detecting sampling manipulation, and providing forensic analysis capabilities in Large Language Model (LLM) and generative AI systems.

The invention addresses the intersection of cryptographic random number generation, information-theoretic statistical forensics, machine learning security, and semantic analysis. Specifically, this invention concerns ENTROPY INTEGRITY MONITORING—the detection of unauthorized manipulation of entropy sources—as distinguished from ENTROPY INJECTION—the deliberate addition of randomness for defensive or exploratory purposes. This distinction defines a novel security domain not addressed by prior art.

### 2. BACKGROUND OF THE INVENTION

### 2.1 the Determinism Illusion in LLMs

Large Language Models are widely characterized as ‘black boxes’-systems whose internal operations may be opaque to external observers. In many deployments, however, the inference pipeline is largely deterministic given fixed inputs, model weights, runtime configuration, and sampling parameters. The inference pipeline comprises six discrete steps, of which the final step introduces non-determinism when stochastic sampling is enabled:

Step 1—Tokenization: Deterministic conversion of input text to token IDs.

Step 2—Embedding: Deterministic lookup of token vectors from fixed embedding tables.

Step 3—Attention: Deterministic matrix multiplications computing attention weights.

Step 4—Feed-Forward: Deterministic neural network computations across all layers.

Step 5—Output Projection: Deterministic multiplication producing probability distribution.

Step 6—Sampling: STOCHASTIC selection based on probability distribution and entropy source.

### 2.2 The Entropy Fissure

A primary point of non-determinism in LLM inference occurs at Step 6: Sampling. When temperature>0, the system selects a token from the probability distribution. This selection consumes a randomness source—typically a Pseudo-Random Number Generator (PRNG) or True Random Number Generator (TRNG). This ‘entropy fissure’ represents a high-leverage point where external influence can affect LLM output without modifying model weights, input data, or deterministic neural computations.

An adversary who gains control of the entropy source can systematically bias model outputs while leaving no trace in conventional monitoring systems. The model weights remain unchanged. The input prompt appears normal. The computational pipeline operates correctly. Yet the outputs are compromised.

### 2.3 Critical Conceptual Distinction: Integrity Vs. Injection

A critical distinction must be drawn between two fundamentally different approaches to entropy in AI systems:

ENTROPY INJECTION (Conventional Technique): Deliberate introduction of randomness into a system to achieve defensive or exploratory objectives. Examples include Address Space Layout Randomization (ASLR) in cybersecurity, noise injection in reinforcement learning for exploration, and Moving Target Defense strategies. These approaches ADD entropy to increase unpredictability. The system controls what entropy enters. Such systems assume a trusted entropy source.

ENTROPY INTEGRITY (Present Invention): Monitoring and forensic analysis of the entropy source to DETECT unauthorized manipulation or compromise. The system does not inject entropy; it monitors the existing entropy pathway to ensure it has not been tampered with. The system detects when adversaries or other external actors have influenced what entropy enters. Such systems assume the entropy source itself may be compromised.

This distinction is fundamental. Entropy injection systems assume a trusted entropy source and add controlled randomness. Entropy integrity systems assume the entropy source itself may be compromised and provide detection, forensics, and attribution capabilities. The present invention addresses the latter-a security domain commonly not addressed by conventional LLM monitoring, content-safety, or post-hoc forensics tooling.

The Predictive Heisenberg Contamination Interface (PHCI, U.S. Provisional 63/865,604) in the QSP-EF family addresses observer-induced contamination during measurement-a form of controlled entropy injection for probing purposes. The present EIF invention is complementary but distinct: while PHCI manages intentional probe-induced uncertainty, EIF detects unintentional or adversarial manipulation of the entropy source itself.

### 2.4 Recognized Technical Problem and Limitations of Conventional Approaches

Recent research has shown that adversaries can exploit weaknesses in pseudo-random number generation and entropy-consumption pathways to bias or predict stochastic sampling outcomes in generative models, including by manipulating seeds, PRNG state evolution, or entropy interfaces.

Conventional mitigations typically treat randomness as an internal implementation detail, rely on offline validation, or log only high-level outputs. As a result, they may fail to provide (i) in-line capture of entropy events at the sampling layer, (ii) tamper-evident binding between entropy draws and selected tokens, and (iii) policy-gated remediation actions executed during inference.

Some approaches use uncertainty- or entropy-derived signals at the model-output layer for anomaly detection or governance. Such approaches are generally post-hoc, are not coupled to the entropy draw pathway that drives token selection, and do not support replay verification of sampling events using cryptographically committed entropy records.

Accordingly, there remains a need for an in-line sampling-layer framework that preserves a verifiable entropy-event record, correlates deviations across instances and time windows, and enforces policy-gated controls when manipulation is detected.

EIF may employ entropy-source validation practices consistent with established randomness standards (e.g., health tests and min-entropy estimation for non-deterministic entropy sources; see, e.g., NIST SP 800-90B [3]) while extending those practices to the specific context of LLM inference-time sampling.

Emergency-control mechanisms for AI systems may include operator-initiated shutdown or containment (see, e.g., Williams et al., 2025 [6]). EIF differs by enabling automated, policy-gated corrective actions triggered by detected entropy anomalies, including fail-closed operation and entropy-source switching when integrity cannot be verified.
LLM token sampling as an attack surface
Real-time detection systems for entropy manipulation
Forensic analysis and audit trail capabilities
Cross-instance coordination detection
Integration with semantic analysis frameworks
Intent classification of detected anomalies

### 2.5 Model-Intrinsic Sampling Drift and False-Positive Control

Recent research has observed that stochastic decoding can exhibit systematic distributional shifts driven by decoding heuristics and concept prototypicality, effectively combining descriptive likelihood with prescriptive idealization. Such endogenous shifts can create divergence between an expected token-selection distribution and an observed distribution even when the entropy source and entropy pathway are uncompromised (see, e.g., arXiv: 2402.11005v3 (not admitted to be prior art), “A Theory of LLM Sampling: Part Descriptive and Part Prescriptive”).

Accordingly, in one or more embodiments, EIF calibrates expected-versus-observed divergence thresholds using rolling baselines, control prompts, and concept-isolated evaluation tasks, thereby reducing false positives by distinguishing (i) model-intrinsic sampling drift consistent with stable decoding behavior from (ii) entropy-pathway anomalies consistent with external manipulation or tampering.

Where divergence is observed without corresponding anomalies in entropy telemetry, cross-instance coordination signals, or tamper-evident logs, the system may classify the event as a benign intrinsic drift condition and continue operation in a monitored mode; whereas divergence coupled to entropy-pathway irregularities may be classified as an Entropy Injection Signature (EIS) triggering gating and/or fail-closed responses as described herein.
Attribution of manipulation to threat actors

Emerging work in media forensics has begun applying entropy analysis to detect manipulation. For example, some proprietary Temporal Entropy Integrity Score (TEIS) approaches examine noise patterns over time in audio/video to expose deepfakes and forgeries. However, such methods operate external to the generative model-they analyze finished media outputs after generation is complete. The present invention operates internal to the inference loop, monitoring the entropy source before token selection occurs.

The present invention extends the problem domain recognized by Dahiya et al. to LLM security and provides a comprehensive operational framework for detection, forensics, and attribution of entropy manipulation in generative AI systems. Where prior art identified the vulnerability, the present invention provides an in-line supervisory solution compatible with real-time inference.

### 3. SUMMARY OF THE INVENTION

### 3.1 Overview and Technical Improvement

The present invention provides a computer-implemented security framework for Large Language Model (LLM) and generative AI inference that detects, classifies, and forensically attributes unauthorized manipulation of the stochastic sampling process through compromise of the entropy pathway. The invention operates INTERNAL to the inference loop, as a supervisory layer positioned BETWEEN an entropy source and an LLM sampling mechanism, such that entropy values are monitored and validated BEFORE token selection occurs.

The present invention provides specific technical improvements to the functioning of LLM inference systems. In one or more embodiments, the EIF framework improves computer security by adding an in-line security layer with low-latency overhead and early-exit optimization. The system prevents manipulation of entropy sources from altering sampling trajectories without detection, creates cryptographically-secured audit trails for online forensic analysis, and enables real-time attribution of detected anomalies to threat actor profiles. These improvements provide an in-line security perimeter at the sampling layer that constrains and verifies entropy consumption prior to token selection, enabling evidence preservation, replay verification, and policy-gated remediation within the inference loop.

### 3.2 Technical Effects and Practical Application

The EIF improves the security and integrity of computer-implemented LLM inference by: (i) instrumenting and validating the entropy pathway and token sampling mechanism at runtime; (ii) detecting entropy manipulation and correlated perturbations across concurrent instances; (iii) generating machine-actionable integrity signals (EIS alerts) with provenance suitable for automated enforcement and audit; (iv) maintaining tamper-evident cryptographic audit trails; and (v) enabling policy-driven corrective actions including fail-closed modes. In some embodiments, technical effects are measurable, including low detection latency, verifiable cryptographic chain integrity, and alerts consumable by downstream SIEM/SOAR systems.

The technical problem addressed by the present invention is the vulnerability of the stochastic sampling process in LLM inference to adversarial manipulation through compromise of the entropy pathway—an attack surface that remains invisible to conventional content-safety, prompt-injection, and post-hoc forensics tooling. The technical solution instrumentes and controls the sampling-layer randomness pathway by: (a) intercepting entropy values at the point of consumption before token selection; (b) computing integrity metrics that detect statistical anomalies indicative of manipulation; (c) preserving tamper-evident evidence enabling forensic replay verification; and (d) executing policy-gated corrective responses proportionate to the detected threat classification. These technical improvements transform the sampling layer from an unmonitored attack surface into a security-instrumented perimeter with real-time detection, forensic attribution, and automated remediation capabilities.

### 3.3 Real-Time Performance

The framework is engineered for low overhead per sampling event using: (1) vectorized operations on pre-allocated buffers; (2) incremental/streaming computation over rolling windows; (3) parallel execution of independent modules; (4) threshold-based early exit; and (5) optional GPU acceleration. In practical deployments, the LLM forward pass typically dominates runtime, and the supervisory layer is designed to add only a small additional overhead relative to that forward pass, subject to configuration and triggered modules.

### 3.4 Integrated Module Set

The present invention provides a computer-implemented system comprising nine integrated modules:
1. Entropy Source Integrity Monitor (ESIM) (112): Statistical validation with ECP analysis
2. Sampling Distribution Forensics (SDF) (114): KL-divergence and Fisher-Rao distance metrics
3. Cross-Instance Correlation Detector (CICD) (116): CCPI and topological analysis
4. Temporal Entropy Forensics (TEF) (118): Persistence-weighted cryptographic audit trails
5. Intent Classification Layer (ICL) (120): Conditional entropy and meta-indicator classification
6. Quantum Random Number Generator Anchor (QRNG-A) (122): Fubini-Study distance baseline (optional)
7. Chain-of-Thought Manipulation Monitor (CTM) (124): Reasoning pathway consistency
8. Sampling Parameter Integrity (SPI) (126): Parameter bound validation
9. Attribution/Provenance Layer (APL) (128): Threat actor signature correlation

### 3.5 Entropy Injection Signature (EIS)

The invention introduces a novel deviation category-Entropy Injection Signature (EIS)—integrated with a unified deviation taxonomy (PS/CCS/MCD/LCS/EIS). Critical distinction: ‘Entropy Injection Signature’ refers to the detectable signature left by unauthorized entropy injection BY AN EXTERNAL ACTOR—not injection by the system itself. The system DETECTS injection; it does not PERFORM injection.

### 3.6 Degraded and Fail-Closed Modes

In one or more embodiments, the EIF supports degraded operation and fail-closed modes. When the system cannot establish sufficient confidence in entropy integrity (e.g., ESIM tests fail, baseline unavailable, or CICD cannot reach quorum), the system may: (i) operate in logging-only mode with elevated verbosity; (ii) force deterministic sampling (temperature=0) for a bounded interval; (iii) block sampling entirely and return an error to the caller; or (iv) quarantine the affected instance. The fail-closed behavior is policy-configurable and may vary by deployment criticality.

### 3.7 Technical Implementation Notes (Non-Limiting)

The disclosed embodiments improve computer security and reliability of LLM inference by intercepting and validating entropy and sampling-distribution signals at runtime, generating machine-actionable integrity classifications (EIS) and tamper-evident audit records, and controlling execution paths via early-exit, fail-closed, and policy enforcement. These operations are implemented using concrete data structures including entropy vectors, distribution snapshots or digests, and hash-chained logs, and are executed as part of the inference-time sampling control flow to harden the token-selection pathway against manipulation.

### 4. BRIEF DESCRIPTION OF THE DRAWINGS

FIG. 1 is a system architecture diagram showing the EIF supervisory layer (110) positioned between the entropy source (100) and LLM sampling mechanism (130), with modules ESIM (112), SDF (114), CICD (116), TEF (118), ICL (120), QRNG-A (122), CTM (124), SPI (126), and APL (128).

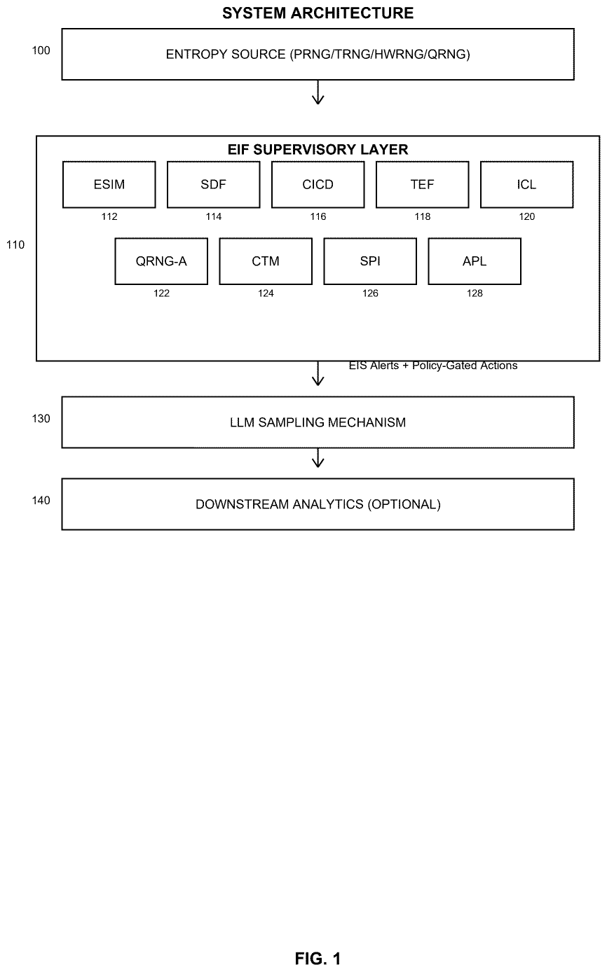

FIG. 2 is a diagram showing the mathematical metric flow (200-270) through the EIF modules, from entropy source (200) through ESIM (210), SDF (220), CICD (230), TEF (240), ICL (250), to EIS alert (260) and policy-gated corrective action (270).

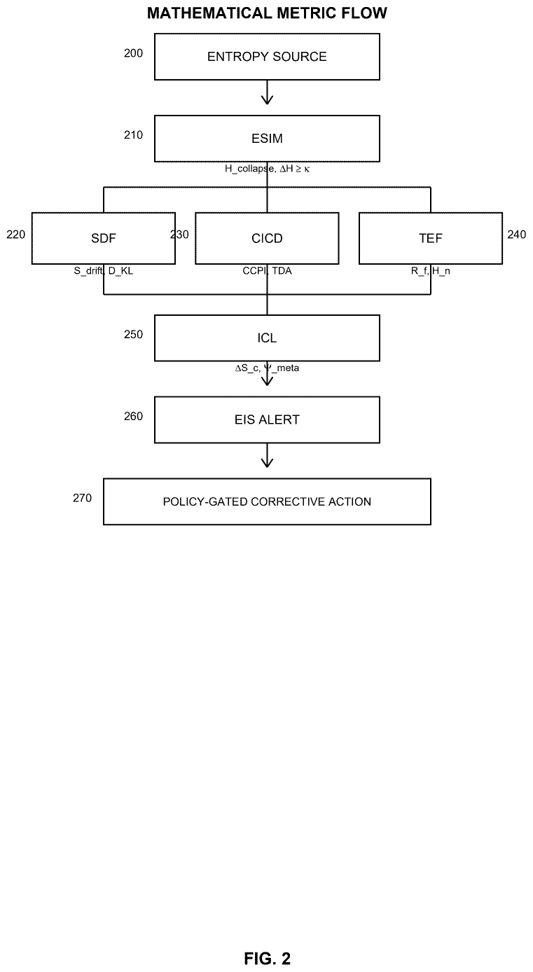

FIG. 3 is a flowchart (300-370) illustrating the entropy validation process from intercept (300) through ESIM metrics computation (310), threshold check (320), SDF metrics (330), TEF audit trail update (340), ICL classification (350), EIS alert generation (360), and corrective action execution (370).

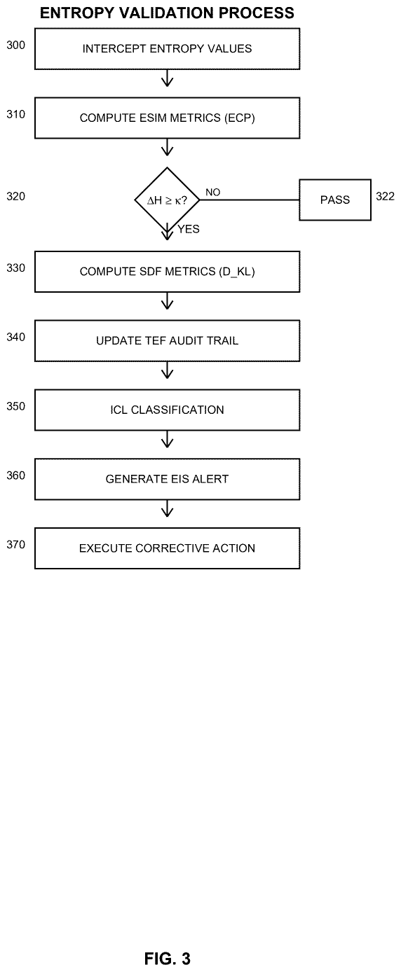

FIG. 4 is a diagram illustrating the EIS deviation taxonomy (400-440), showing EIS categories (410-418), integration with DIM (420), semantic categories (430), and downstream forecasting/analytics (440).

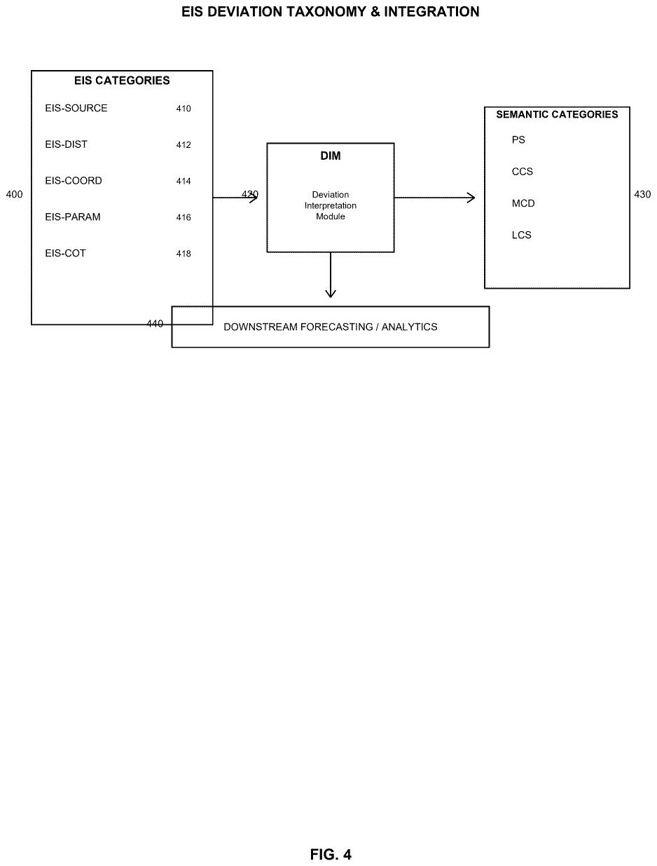

FIG. 5 is a threat model diagram (500-530) showing attack vectors (TM-001 through TM-008), detection module mappings (510-524), and detection responses (530) including fail-closed, deterministic fallback, source switching, and quarantine operations.

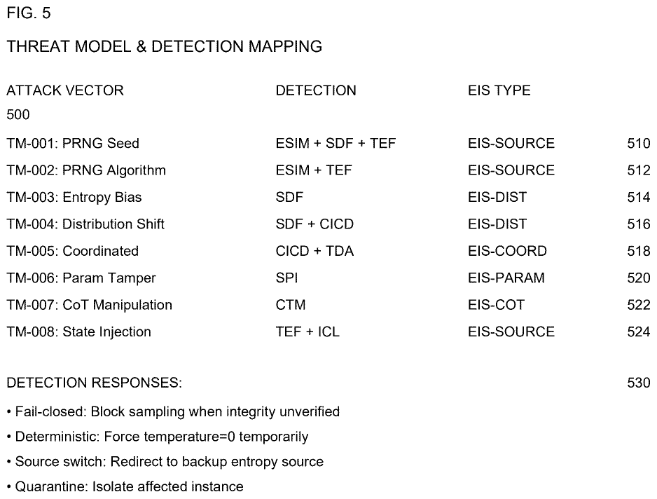

### 5. DEFINITIONS AND INTERPRETATION

The following definitions apply throughout this specification and claims unless the context indicates otherwise:

### “Entropy Source”

Any mechanism providing randomness or pseudo-randomness used by an LLM sampling mechanism, including but not limited to PRNGs, TRNGs, hardware RNGs, and optional QRNGs.

### “Sampling Mechanism”

A token selection process that consumes entropy values to select a token from a probability distribution produced by a generative model, including temperature sampling, top-k, top-p nucleus sampling, and stochastic beam variants.

### “Before Token Selection”

Prior to the final discrete selection of an output token at the stochastic sampling step of inference.

### “Supervisory Layer Positioned Between”

A configuration wherein entropy values are intercepted, buffered, validated, or otherwise processed by the invention prior to being used by the sampling mechanism.

### “Entropy Integrity”

The property that the entropy source and entropy pathway have not been tampered with, biased, externally influenced, or otherwise compromised.

### “Entropy Injection Signature (EIS)”

A detectable signature indicating anomaly at the entropy source and/or sampling mechanism level consistent with unauthorized injection or influence by an EXTERNAL ACTOR. EIS is a DETECTION category. The invention DETECTS such injection; it does NOT perform injection itself.

### “QRNG-A”

A module providing comparison against a baseline entropy source. The Fubini-Study distance metric is a computational geometric distance applicable with or without quantum hardware. Use of actual QRNG hardware is an optional embodiment.

### “CTM (Chain-of-Thought Manipulation Monitor)”

A module that monitors for manipulation of reasoning pathways. CTM supports black-box compatible mode when internal model states are not accessible, relying on observable outputs and declared parameters.

### “Low-Latency Overhead”

In one or more embodiments, the supervisory computations introduce low overhead per sampling event. Such low overhead may be achieved through vectorized operations, pre-allocated buffers, incremental computation, parallel module execution, threshold-based early exit, and/or asynchronous persistence of audit records.

### “Baseline”

A reference distribution or metric value derived from prior validated sampling events and/or controlled test conditions, including rolling windows.

### “Expected Distribution”

The reference distribution used for sampling-distribution comparison. In a white-box deployment, the expected distribution may be obtained from model probability outputs (e.g., logits or normalized probabilities) exposed by an inference interface. In a black-box deployment, the expected distribution may be estimated from prior validated sampling events, including rolling-window baselines and smoothed token-frequency histograms.

### “Observed Token-Selection Distribution”

An empirical distribution estimated from output token selections observed over a sliding window of sampling events, including token-frequency histograms, n-gram frequency statistics, or other observable selection summaries.

### “Semantic Embedding Vectors (ψ)”

Vector representations used for semantic drift and cross-instance correlation metrics, including ψ_t, ψ_hist, ψ_local, and ψ_global. In one or more embodiments, ψ vectors are computed by an embedding model applied to text, token sequences, or intermediate structured outputs; in black-box deployments, v vectors may be computed by an external encoder over observable outputs.

“Threshold Parameters (κ, θ_adv, τ1, τ2, λ)”

Thresholds and decay terms used for triggering alerts and persistence weighting. These parameters are domain-adaptive and may be computed over rolling windows.

### “Fail-Closed Mode”

An operational mode wherein the system blocks or restricts sampling when entropy integrity cannot be verified with sufficient confidence, preventing potentially compromised outputs from being generated.

### “Policy-Gated Corrective Action”

A corrective action (such as switching entropy source, forcing deterministic sampling, or quarantining an instance) that is executed automatically by the system based on predefined policy rules when integrity thresholds are exceeded.

### “Intent Classification Categories”

The ICL classifies detected anomalies into one of the following categories: (i) ADVERSARIAL—indicating deliberate manipulation by an external actor; (ii) BENIGN STOCHASTIC—indicating normal stochastic variation without evidence of manipulation; (iii) HARDWARE_DEGRADATION-indicating entropy-source noise or degradation requiring maintenance but not indicating adversarial activity; and optionally (iv) INDETERMINATE—an operational state indicating insufficient evidence to assign a final classification, triggering continued monitoring or escalation.

### 6. MATHEMATICAL FOUNDATIONS

The EIF framework employs a comprehensive mathematical arsenal derived from information theory, statistical mechanics, and information geometry.

### 6.1 Entropy of Collapse Paths (ECP)—ESIM Core Metric

$$H\_collapse = - {Σ}_{i} {p}_{i} log {p}_{i}$$

where pᵢ represents the probability of collapse path i. In practice, pᵢ is computed by binning observed entropy values over a sliding window of W samples (typical range: W=256 to 8192). An ECP differential ΔH>κ triggers corrective action, where:

In one or more embodiments, a “collapse path” refers to an ordered sequence of token-selection outcomes within a generation window W of length T, under a specified sampling regime (e.g., temperature, top-k, top-p) and entropy source. For a candidate trajectory π=(t1, t2, . . . , tT) with conditional token probabilities Pj(tj|contextj, paramsj), the path probability may be defined as P(π)=Π_{j=1 . . . T} Pj(tj|contextj, paramsj). ECP may be computed over a set ΠW of trajectories induced by the sampling regime, for example via Monte Carlo sampling or bounded expansion, thereby capturing sequential decision dynamics of autoregressive sampling rather than a static single-step entropy of a next-token distribution.

Accordingly, ECP is distinguished from (i) Shannon entropy computed on a single next-token distribution at a single step, (ii) min-entropy estimators applied to an entropy source in isolation, and (iii) higher-moment shape tests (e.g., skewness or kurtosis) applied to raw noise values. EIF uses ECP as a security-oriented integrity metric for detecting anomalous collapse dynamics that may indicate manipulation of inference-time token sampling.

$$κ = μ\_H + n σ\_H$$

with n typically set to 2 or 3 standard deviations.

### 6.2 Semantic Drift Score (SDS)—SDF Primary Metric

$$S\_drift ( t ) = 1 - cos ( {ψ}_{t} , ψ\_hist )$$

The threshold θ_adv follows adaptive dynamics:

$$θ\_adv = μ\_drift + 2 σ\_drift$$

### 6.3 Cross-Contextual Perturbation Index (CCPI)—CICD Core Metric

$$CCPI = ‖ ψ\_local - ψ\_global ‖ / ‖ ψ\_global ‖$$

where ψ_local is the current instance embedding and ψ_global is the aggregate across concurrent instances (minimum N≥10).

### 6.4 Fisher-Rao Distance-SDF Secondary Metric

$$d\_FR ( P , Q ) = arccos ( {Σ}_{i} √ ( {p}_{i} {q}_{i} ) )$$

### 6.5 Fubini-Study Distance-QRNG-A Metric

$$d\_FS ( \vert ψ 〉 , \vert ϕ 〉 ) = arccos ( \vert 〈 ψ \vert ϕ 〉 \vert )$$

### 6.6 Conditional Entropy Differential-ICL Classification

$$ΔS\_c = H ( ψ\_max \vert ψ\_hist ) - H ( ψ\_obs \vert ψ\_hist )$$

Combined with persistence weighting:

$$R\_f = α \cdot P\_k + β \cdot e \hat{} ( - λ t )$$

$$Classification = ADVERSARIAL if ΔS\_c < {τ}_{1} AND R\_f > {τ}_{2}$$

### 6.7 Composite Meta-Indicator-ICL Aggregate Score

$$Ψ\_meta = {Σ}_{i} {w}_{i} \cdot {m}_{i}$$

where mᵢ ∈{C_f, C_d, E_log, E_max, Q_c, X_adapt}. Weights wᵢ are auto-adjusted and may be negative.

### 6.8 KL-Divergence-SDF Distribution Comparison

$$D\_KL ( O \vert \vert E ) = {Σ}_{t} O ( t ) \cdot log ( O ( t ) / E ( t ) )$$

### 6.9 Martingale-Based Drift Detection-TEF Online Monitoring

$$M\_t = M\_ \{ t - 1 \} \cdot ( p\_t / q\_t )$$

### 7. DETAILED DESCRIPTION OF PREFERRED EMBODIMENTS

### 7.1 System Architecture Overview

The EIF framework operates as a supervisory layer (110) positioned between the entropy source (100) and the LLM sampling mechanism (130, 140). All entropy values pass through EIF before reaching the sampling function.

In one or more embodiments, an Entropy Injection Signature (EIS) is defined with respect to inference-time autoregressive token sampling for LLMs, including manipulation of sampling parameters or RNG state that affects the token probability distribution and selection outcomes. This differs from signatures defined for training-time noise distributions (e.g., randomized smoothing) because EIF evaluates and logs sampling-layer events and collapse dynamics during inference, enabling direct forensic attribution of generated outputs to sampling integrity.

PERFORMANCE DESIGN: In one or more embodiments, the EIF architecture is engineered to reduce runtime overhead by (1) early-exit control; (2) optional parallel module execution; (3) bounded-window statistics; (4) buffered or asynchronous persistence for audit records; and (5) optional hardware acceleration. Actual latency may vary by model, hardware, and deployment configuration, and certain implementations may achieve low overhead.

### 7.1.1 Event Flow and Early-Exit Control

EIF evaluates a hierarchy of checks. If early checks pass (e.g., ESIM statistical sanity within bounds), EIF may skip deeper computation (e.g., CICD topological analysis), thereby controlling overhead. Modules may execute in parallel where independence permits.

### 7.2 Entropy Source Integrity Monitor (ESIM) (112)

ESIM validates entropy quality through continuous statistical analysis and information-theoretic metrics.

### Statistical Test Battery:

Frequency Test: χ² validation of uniform distribution
Runs Test: Detection of non-random sequential patterns
Serial Test: Correlation analysis between consecutive values
Autocorrelation Test: Periodic pattern detection at multiple lags
Entropy Estimation: Shannon entropy H=−Σp log p
ECP Analysis: Collapse path entropy

### Implementation (Pseudocode):

```
class ESIM:
  def validate(self, entropy_value):
    self.window.append(entropy_value)
    freq_p = frequency_test(self.window)
    runs_p = runs_test(self.window)
    ecp = entropy_collapse_paths(self.window)
    delta_H = ecp − self.baseline_ecp
    if delta_H >= self.kappa:
      return EIS_Alert(type=‘EIS-SOURCE’, severity=delta_H)
    return None
```

### 7.3 Sampling Distribution Forensics (SDF) (114)

SDF compares observed token selection behavior against expected model probabilities.

Fisher Discriminant Analysis: Adapted from high-energy physics, SDF implements Fisher discriminants:

$$F ( x ) = w \cdot x , where w = S\_W \hat{} ( - 1 ) ( μ\_anomaly - μ\_normal )$$

### 7.4 Cross-Instance Correlation Detector (CICD) (116)

CICD detects coordinated manipulation across concurrent LLM instances.

In one or more embodiments, EIF instances emit signed “correlation summaries” comprising CCPI values and/or CCPI components, an entropy-deviation metric vector (e.g., AECP statistics, varentropy/entropy variance, min-entropy estimates, normality-test p-values, and/or EIS category indicators), time-window identifiers, and deployment metadata to a correlation service via a secure communication protocol (e.g., mutually authenticated TLS over gRPC or HTTPS). The correlation service aggregates summaries over a defined temporal window and computes cross-instance correlation scores to detect synchronized entropy anomalies indicative of coordinated manipulation. Federated embodiments may transmit only privacy-preserving sketches, hashes, or differentially private aggregates rather than raw per-event data.

In one or more embodiments, cross-instance correlation is performed using entropy deviation metrics as the correlation signal, including one or more of: ECP differentials across token steps, divergence measures between expected and observed sampling distributions, and EIS category indicators. This entropy-metric-based correlation distinguishes coordinated manipulation from isolated anomalies that may arise from benign stochastic variation or transient deployment conditions.

In one or more embodiments, cross-instance correlation employs a temporal correlation window W_corr (e.g., 1-60 seconds, configurable per deployment) during which entropy deviation metrics from multiple instances are aggregated. Correlation scores are computed by: (1) normalizing per-instance entropy metrics to z-scores relative to instance-specific baselines (μ_i, σ_i); (2) computing pairwise correlation coefficients across instances within W_corr; (3) applying a correlation threshold θ_corr (e.g., θ_corr≥0.7) to identify statistically significant cross-instance coordination; and (4) weighting correlations by temporal proximity using an exponential decay kernel. When the aggregated coordination score exceeds a policy-defined alarm threshold, CICD emits an EIS-COORD alert indicating potential coordinated manipulation across the monitored instance population.

Topological Data Analysis (TDA): Employing persistent homology to detect structural anomalies. The system constructs a dynamic Vietoris-Rips complex and computes persistence diagrams.

Dalitz-Inspired Multi-Dimensional Mapping: Adapted from particle physics, CICD creates correlation plots mapping CCPI, temporal correlation, and semantic similarity across instance pairs.

### 7.5 Temporal Entropy Forensics (TEF) (118)

TEF maintains cryptographically-secured audit trails:

$$H\_n = HASH ( event\_n ‖ H\_ \{ n - 1 \} ‖ timestamp\_n )$$

In one or more embodiments, each event_n comprises an “entropy event record” capturing non-content metadata sufficient to support forensic reconstruction of sampling decisions, including: (i) a deployment or instance identifier; (ii) a generation step index; (iii) a digest of the pre-sampling probability distribution (e.g., a hash of logits or a hashed summary vector); (iv) sampling regime parameters (including temperature, top-k, top-p, and any authorized bounds); (v) an entropy-source identifier and RNG provider; (vi) RNG state or seed material as permitted by policy; (vii) one or more random draws used in sampling; (viii) the selected token identifier; and (ix) a cryptographic commitment token that binds the selected token identifier to the entropy event record and to the hash-chain state, enabling tamper-evident replay verification and third-party verification in black-box deployments. Content-bearing text payloads need not be logged, and privacy-preserving embodiments may store only cryptographic commitments or hashed summaries.

The following illustrative JSON Lines (JSONL) record demonstrates one non-limiting embodiment of an entropy event record structure:

{“instance_id”:“eif-prod-7a3b”,“step”:42,“ts”:“2026-01-12T14:32:01.123Z”,
“logits_hash”:“sha256:9f86d08...”,“params”:{“T”:0.7,“top_k”:40,“top_p”:0.95},
“rng”:{“provider”:“MT19937”,“seed_commit”:“sha256:a3c1e...”,“draws”:[0.7234]},
“token_id”:15234,“commit”:“sha256:7c4a...”,“chain_prev”:“sha256:b2f1...”}

Replay Verification Procedure: Given an entropy event record and the specified sampling regime, a verifier executes the following steps: (1) retrieve the recorded RNG state/seed commitment and verify against stored policy; (2) reconstruct the candidate token set by applying recorded sampling parameters (temperature, top-k, top-p) to the logits distribution (identified by logits_hash); (3) replay the recorded random draw(s) against the candidate set to determine the expected selected token; (4) compare the replayed selection against the recorded token_id; (5) verify the cryptographic commitment binds (token_id∥rng_draws∥logits_hash) correctly; and (6) verify chain linkage by confirming H_n=HASH (record_n∥chain_prev). A mismatch at any step indicates potential tampering or record corruption.

Given the entropy event records and the specified sampling regime, a verifier may perform an “entropy replay” procedure to confirm that observed token selections are consistent with the logged entropy events and parameters, thereby enabling post-hoc attribution and tamper detection even when the LLM itself is treated as a black box. Martingale Monitoring: Multiple martingales M_t monitor different aspects. Growth in specific martingale identifies affected component for causal diagnosis.

### 7.6 Intent Classification Layer (ICL) (120)

ICL classifies detected anomalies. Classification Logic (pseudocode):

```
def classify_intent(psi_obs, psi_hist, psi_max, params):
  delta_Sc = H_cond(psi_max, psi_hist) − H_cond(psi_obs, psi_hist)
  R_f = params.alpha * persistence(psi_obs, k) + \
      params.beta * exp(−params.lambda * time_delta)
  psi_meta = weighted_sum([Cf, Cd, E_log, E_max, Qc, X_adapt],
  weights)
  if delta_Sc < tau1 and R_f > tau2 and psi_meta > 0.85:
    return ‘ADVERSARIAL’
  elif is_hardware_noise_signature(features):
    return ‘HARDWARE_DEGRADATION’
  else:
    return ‘INDETERMINATE’
```

### 7.7 Quantum Random Number Generator Anchor (QRNG-A) (122)

QRNG-A provides optional reference entropy baseline using Fubini-Study distance. QRNG hardware is optional; EIF remains operable with PRNG/TRNG sources.

### 7.8 Chain-of-Thought Manipulation Monitor (CTM) (124)

CTM supports both white-box and black-box compatible modes:
White-box: Monitor intermediate tokens, logits, or exposed traces
Black-box: Monitor proxy observables including step-wise entropy, log-probability stability, and self-consistency

### 7.9 Sampling Parameter Integrity (SPI) (126)

SPI detects unauthorized modification of sampling parameters (temperature, top-k, top-p, seeds) through bound validation, change authorization checks, and parameter-context coherence detection.

### 7.10 Attribution/Provenance Layer (APL) (128)

APL correlates EIS events to provenance and potential threat-actor signatures by storing a signature library, correlating with runtime provenance (host identity, container hash, RNG provider), and generating attribution scores.

### 7.11 Corrective Actions

Upon detecting anomalies, EIF may execute policy-gated corrective actions:
Escalating from early-exit mode to full analysis
Forcing deterministic sampling (temperature→0)
Reseeding or switching entropy source
Increasing TEF audit verbosity
Blocking requests or quarantining instances (fail-closed)

Policy-gated corrective actions may include, without limitation: fail-closed halting, sampling-parameter lockdown, entropy reseeding, entropy source switching, and entropy blending (dynamic weighting of multiple entropy sources). In one or more embodiments, the selected action is conditioned on the intent classification output (e.g., adversarial manipulation vs. benign stochastic deviation vs. entropy-source degradation), enabling proportionate response without unnecessary disruption to benign inference operations.

The following table illustrates non-limiting examples of policy-gated action mappings:
TRIGGER CONDITION|ACTION|TEF AUDIT FIELDS UPDATED

ICL=ADVERSARIAL, ΔH≤3σ | Fail-closed halt | action_type, halt_reason,
eis_alert_id
ICL=ADVERSARIAL, ΔH<3σ | Entropy source switch | prev_source, new_source,
switch_ts
ICL=HARDWARE_DEGRADATION | Entropy blending (50/50) | blend_weights,
source_ids, blend_ts
ICL=BENIGN_STOCHASTIC | Log + continue | anomaly_logged, continue_flag
ICL=INDETERMINATE | Escalate + full analysis | escalation_ts, full_analysis_flag
CCPI≥θ_coord (EIS-COORD) | Quarantine instance | quarantine_ts, instance_id,
ccpi_val
SPI violation detected | Parameter lockdown | locked_params, lockdown_ts, spi_alert
TEF chain break detected | Force deterministic (T=0) | force_determ_ts, prev_T,
chain_status

### 8. DEVIATION TAXONOMY

### 8.1 Optional Semantic Deviation Taxonomy

PS—Predictive Shift: Divergence between predicted and observed semantic trajectories.

CCS—Cross-Contextual Signature: Deviation pattern across multiple contexts.

MCD—Mandela-Class Deviation: High-confidence false pattern contradicting ground truth.

LCS—Latent Collapse Signature: Low-amplitude early warning indicator.

### 8.2 EIS Category (Present Invention)

EIS—Entropy Injection Signature: Anomaly at entropy source or sampling mechanism level. Sub-Categories:
EIS-SOURCE: Entropy source integrity violation (detected by ESIM)
EIS-DIST: Sampling distribution anomaly (detected by SDF)
EIS-COORD: Cross-instance coordination (detected by CICD)
EIS-PARAM: Sampling parameter manipulation (detected by SPI)
EIS-COT: Chain-of-thought manipulation (detected by CTM)

### 9. THREAT MODELS

TM-001: PRNG Seed Manipulation—Adversary manipulates seed for predictable sequences. Detection: ESIM/ECP, SDF, TEF martingale.

TM-002: PRNG Algorithm Substitution—Compromised PRNG version. Detection: ESIM statistical battery, TEF long-term analysis.

TM-003: Entropy Bias—Systematic bias in entropy source output. Detection: SDF divergence metrics. EIS Type: EIS-DIST.

TM-004: Distribution Shift—Unexpected shift in token selection distribution. Detection: SDF+CICD correlation. EIS Type: EIS-DIST.

TM-005: Coordinated Multi-Instance Attack—Manipulation across multiple concurrent instances. Detection: CICD/CCPI, TDA. EIS Type: EIS-COORD.

TM-006: Sampling Parameter Tampering—Unauthorized modification of temperature, top-k, top-p, or seed. Detection: SPI validation. EIS Type: EIS-PARAM.

TM-007: Chain-of-Thought Manipulation—Intermediate reasoning pathway steering through entropy manipulation. Detection: CTM consistency monitoring. EIS Type: EIS-COT.

TM-008: State Injection—Adversarial injection of crafted internal state to influence sampling outcomes. Detection: TEF+ICL anomaly correlation. EIS Type: EIS-SOURCE.

### 10. IMPLEMENTATION PROTOCOLS AND WORKED EXAMPLES

The worked examples in Sections 10.2-10.5 are illustrative, non-limiting operational simulations provided to demonstrate how the disclosed modules may function and to support enablement; they are not assertions of experimentally measured performance unless expressly stated otherwise.

### 10.1 Common Implementation Assumptions

Non-limiting parameter ranges: rolling window W=256-8192 events; κ and θ_adv set by μ+nσ rules; persistence horizon k=3-100 events; early exit skips deeper modules if initial checks pass.

### 10.2 Worked Example A: EIS-SOURCE Detection

Procedure: (1) Collect baseline window W=1024 entropy draws. (2) Introduce compromise pattern (periodic bias P=127). (3) Compute H_collapse and ΔH. (4) When ΔH≥κ (κ=2.50), emit EIS-SOURCE alert. Illustrative outcome: Attack may be detected within approximately 1024 events.

### 10.3 Worked Example B: EIS-DIST Detection

Procedure: (1) Record expected probabilities E (t). (2) Record observed frequencies O(t) over 500 tokens. (3) Compute D_KL and d_FR. (4) If D_KL>0.15 and/or d_FR>0.10, emit EIS-DIST. Illustrative outcome: Distribution manipulation may be detected.

### 10.4 Worked Example C: EIS-COORD Detection

Procedure: (1) Deploy N=50 concurrent instances. (2) Compute CCPI per instance. (3) Compute persistence diagrams via TDA. (4) When CCPI>0.25 and persistence>0.3, emit EIS-COORD. Illustrative outcome: Coordinated manipulation may be flagged.

### 10.5 Worked Example D: EIS-PARAM Detection

Procedure: (1) Set authorized bounds (temperature∈[0.7, 1.0], top-k∈[40, 50]). (2) Validate at runtime. (3) Correlate with ESIM/SDF anomalies. (4) Emit EIS-PARAM. Illustrative outcome: Parameter tampering may be detected.

### 10.6 Reference Audit Schema (JSON, Non-Limiting)

```
{
      “event_id”: “uuid”,
      “instance_id”: “opaque_instance_id”,
      “time_utc”: “RFC3339”,
      “gen_step”: 42,
      “sampling_params”: {“temperature”: 0.8, “top_p”: 0.95, “top_k”: 50},
      “entropy_metrics”: {“H_t”: 3.12, “ECP_t”: 0.41, “varentropy_t”: 0.18,
    “min_entropy_t”: 1.90},
      “entropy_source”: {“source_id”: “hwrng|csprng|tee_rng”, “health”: “ok|degraded”,
    “switch_event”: false},
      “rng_telemetry”: {
        “seed_commit”: “sha256:...”,
        “state_commit”: “sha256:...”,
        “draw_commit”: “sha256:...”,
        “draw_count”: 1
      },
  “logits_digest”: “sha256:...”,
  “selected_token”: {“token_id”: 12345, “token_prob”: 0.031, “token_commit”:
“sha256:...”},
  “classification”: “benign|adversarial|hardware”,
  “eis”: {“label”: “EIS−...”, “features_digest”: “sha256:...”},
  “actions”: [“force_deterministic_sampling”, “switch_entropy_source”,
“blend_entropy_sources”],
  “hash_chain_state”: {“H_n”: “sha256:...”, “prev”: “sha256:...”},
  “commitment”: {“commit_token”: “sha256:...”, “binds”:
[“event_id”,“gen_step”,“sampling_params”,“rng_telemetry”,“selected_token”,“hash_chain_st
ate”]}
}
```

### 10.7 Reference Pseudocode: EIF Supervisory Loop

```
  Algorithm EIF_Supervisory_Loop
  Inputs: entropy_stream e_t, logits p_t, sampling_params θ_t
  State: rolling_windows, baseline_models, hash_chain state
  For each sampling event t:
    e_t′ = intercept(e_t) # before token selection
    metrics_E = ESIM(e_t′, rolling_windows, κ)
    metrics_P = SPI(θ_t, policy_bounds)
    if early_exit(metrics_E, metrics_P):
      event_record = build_entropy_event_record(t, e_t′, θ_t, metrics_E, metrics_P,
  rng_state_seed, rng_draw, token_id, logits_digest)
TEF.log(event_record, hash_chain_state)
      forward(e_t′) # allow sampling
      continue
    metrics_D = SDF(p_t, baseline_models)
    metrics_C = CICD(metrics_D, distributed_state)
    intent = ICL({metrics_E, metrics_D, metrics_C, metrics_P})
    eis = classify_EIS(metrics_E, metrics_D, metrics_C, metrics_P)
    actions = policy_actions(eis, intent) # policy-gated
    TEF.log(...)
    apply(actions) # corrective action
    forward(e_t′)
```

### 10.8 Latency Envelope and Early-Exit Protocol

In one or more embodiments, EIF may achieve low overhead via early-exit protocol: lightweight checks (SPI bounds, incremental ESIM) execute on each event; heavier modules (SDF, CICD, TDA, QRNG-A) trigger conditionally. Optimizations include: incremental statistics over rolling windows; vectorized KL/cosine computation; pre-allocated buffers; batched test evaluation; asynchronous TEF persistence.

### 10.9 Enablement Notes for Black-Box Deployments

In black-box deployments where internal logits are not accessible, EIF operates on: declared sampling parameters, output token sequences, timing patterns, and entropy stream validation. SDF uses proxy distribution estimates (token frequency histograms); CTM uses consistency checks between parameters and observed variability. A compliance mode limits collection to non-content metadata.

### 11. ALTERNATIVE EMBODIMENTS

White-Box vs. Black-Box Deployment: Full functionality in white-box; observable signals only in black-box.

Edge Deployment: Lightweight local analysis with central aggregation.

Federated Deployment: Local EIF instances with privacy-preserving CICD aggregation.

QRNG Hardware: Optional; Fubini-Study metric applicable with classical baselines. Hardware-Agnostic: Supports CPU, GPU, quantum, and hybrid systems.

### 12. FAMILY COHERENCE

This application is related to U.S. patent application Ser. No. 19/231,235 (QSP-EF). The EIF mathematical formulations are defined herein for standalone operability; in some embodiments they maintain compatibility with related forecasting frameworks:
Entropy metrics (ECP, H_collapse) entropy interpretation
Semantic drift (SDS) may be optionally mapped to external coherence scoring methodologies
Conditional entropy (ΔS_c) parallels the DIM classification logic
Persistence weighting (R_f) uses same exponential decay philosophy
CCPI extends cross-contextual signature detection to cross-instance domain

### 13. LIST OF ABBREVIATIONS

| Abbreviation | Meaning |
|---|---|
| APL | Attribution/Provenance Layer |
| CCPI | Cross-Contextual Perturbation Index |
| CCS | Cross-Contextual Signature |
| CICD | Cross-Instance Correlation Detector |
| CTM | Chain-of-Thought Manipulation Monitor |
| DIM | Deviation Interpretation Module |
| ECP | Entropy of Collapse Paths |
| EIF | Entropy Integrity and Forensics Framework |
| EIS | Entropy Injection Signature (detection category) |
| ESIM | Entropy Source Integrity Monitor |
| ICL | Intent Classification Layer |
| LCS | Latent Collapse Signature |
| LLM | Large Language Model |
| MCD | Mandela-Class Deviation |
| PRNG | Pseudo-Random Number Generator |
| PS | Predictive Shift |
| QRNG-A | Quantum Random Number Generator Anchor |
| SDF | Sampling Distribution Forensics |
| SDS | Semantic Drift Score |
| SPI | Sampling Parameter Integrity |
| TDA | Topological Data Analysis |
| TEF | Temporal Entropy Forensics |
| TRNG | True Random Number Generator |

### 14. REFERENCES (NON-ADMISSION)

Citation of any reference herein is not an admission that such reference constitutes prior art to the present invention.

### Background Technology (Problem Recognition):

Dahiya, P., Shumailov, I., Anderson, R. (2024). ‘Machine Learning needs Better Randomness Standards.’ USENIX Security 2024.
US20220366223A1, Kanduri et al. (2022). ‘Uncertainty Estimation in Deep Neural Networks.’
Turan, M. S., Barker, E., Kelsey, J., Mckay, K., Baish, M. (2018). NIST SP 800-90B: Recommendation for the Entropy Sources Used for Random Bit Generation. NIST.
Khalid, H. M., Jeyaganthan, A., Do, T., Fu, Y., O'Brien, S., Sharma, V., Zhu, K. (2025). ‘ERGO: Entropy-guided Resetting for Generation Optimization in Multi-turn Language Models.’ arXiv: 2510.14077.
Li, D., Yu, G., Wang, X., Liang, B. (2025). ‘AuditableLLM: A Hash-Chain-Backed, Compliance-Aware Auditable Framework for Large Language Models.’ Electronics 15 (1): 56.
Williams, K., Subramani, R., Ward, F. R. (2025). ‘Password-Activated Shutdown Protocols for Misaligned Frontier Agents.’ arXiv: 2512.03089.

### Distinguished Approaches (Entropy Injection—Different Domain):

Janani, K. et al. (2025). ‘Cybersecurity through Entropy Injection.’ arXiv: 2504.11661.
ASLR and Moving Target Defense literature.

### Distinguished Approaches (External Forensics):

Temporal entropy-based media forensics approaches (e.g., proprietary TEIS-style methods) operating post-hoc on generated audio/video content.

### Mathematical Foundations:

Shannon, C. E. (1948). ‘A Mathematical Theory of Communication.’
Fisher, R. A. (1936). ‘Multiple Measurements in Taxonomic Problems.’
Kullback, S., Leibler, R. A. (1951). ‘On Information and Sufficiency.’
Bengtsson, I., Życzkowski, K. (2006). Geometry of Quantum States: An Introduction to Quantum Entanglement. Cambridge University Press.
Carlsson, G. (2009). ‘Topology and Data.’ Bulletin of AMS.

### Related Applications

U.S. application Ser. No. 19/231,235 (QSP-EF), filed Jun. 6, 2025.
U.S. Provisional 63/865,604 (PHCI), filed Aug. 18, 2025.
U.S. Provisional 63/869,139 (CSL), filed Aug. 23, 2025.

1. A computer-implemented system for entropy integrity monitoring and forensic integrity verification, for detecting and investigating entropy manipulation, in a Large Language Model (LLM) inference environment, comprising:
a processor; and
a non-transitory memory storing instructions that, when executed by the processor, cause the processor to:
(a) intercept, before token selection, entropy values used by a sampling mechanism of the LLM, the entropy values being provided by an entropy source;
(b) compute, by an entropy source integrity monitor (ESIM), one or more entropy integrity metrics comprising (i) statistical test outputs and (ii) an Entropy of Collapse Paths (ECP) measure over a sliding window, and detect an entropy anomaly when a differential of the ECP measure satisfies an adaptive threshold condition;
(c) compute, by a sampling distribution forensics module (SDF), one or more sampling-distribution metrics comprising a divergence between (i) an observed token-selection distribution and (ii) an expected distribution, wherein the expected distribution is obtained from at least one of (A) model probability outputs exposed by an inference interface, or (B) a baseline distribution estimated from prior validated sampling events;
(d) maintain, by a temporal entropy forensics module (TEF), a tamper-evident audit trail comprising a hash chain over event records and a persistence-weighted severity score; and
(e) in response to the entropy anomaly, generate an Entropy Injection Signature (EIS) alert and execute a policy-gated corrective action affecting at least one of (i) the entropy source, (ii) the entropy values, or (iii) one or more sampling parameters of the sampling mechanism.

2. A computer-implemented method for detecting entropy manipulation and enabling forensic verification in Large Language Model systems, comprising:
(a) intercepting, before token selection, entropy values used by a sampling mechanism of an LLM, the entropy values being provided by an entropy source;
(b) computing one or more entropy integrity metrics comprising (i) statistical test outputs and (ii) an Entropy of Collapse Paths (ECP) measure over a sliding window, and determining an entropy anomaly based on an adaptive threshold condition;
(c) computing one or more sampling-distribution metrics comprising a divergence between an observed token-selection distribution and an expected distribution, wherein the expected distribution is obtained from at least one of (i) model probability outputs exposed by an inference interface, or (ii) a baseline distribution estimated from prior validated sampling events;
(d) maintaining a tamper-evident audit trail comprising a hash chain over sampling event records;
(e) generating an Entropy Injection Signature (EIS) alert when one or more integrity metrics exceed one or more thresholds; and
(f) executing, based on the EIS alert, a policy-gated corrective action affecting at least one of (i) the entropy source, (ii) the entropy values, or (iii) one or more sampling parameters of the sampling mechanism.

3. The method of claim 2, further comprising computing a Cross-Contextual Perturbation Index across concurrent instances and applying topological data analysis using persistent homology to detect coordinated manipulation.

4. A non-transitory computer-readable medium storing instructions that, when executed by a processor, cause the processor to perform the method of claim 2.

5. The system of claim 1, further comprising a cross-instance correlation detector (CICD) configured to compute a Cross-Contextual Perturbation Index (CCPI) based at least in part on entropy deviation metrics derived from the intercepted pre-token-selection entropy values and one or more of: (i) ECP differentials across token steps, (ii) divergence measures between expected and observed sampling distributions, and (iii) EIS category indicators, across concurrent LLM instances within a temporal correlation window, wherein elevated CCPI indicates coordinated manipulation.

6. The system of claim 1, further comprising an intent classification layer (ICL), during inference-time token sampling, configured to classify an entropy anomaly into at least: (i) adversarial manipulation, (ii) benign anomaly, or (iii) hardware entropy-source noise or degradation, based at least on a conditional entropy differential and one or more persistence-weighted metrics.

7. The system of claim 1, further comprising a quantum random number generator anchor (QRNG-A) configured to compute a baseline comparison metric for an entropy pathway, wherein the baseline comparison is applicable with or without quantum hardware.

8. The system of claim 5, wherein the CICD employs topological data analysis using persistent homology to detect structural anomalies in cross-instance dependency patterns.

9. The system of claim 6, wherein the ICL computes a composite meta-indicator based on a weighted sum of metric values including at least format complexity, degree complexity, logical entropy, maximum entropy, a quantum coherence index, and adaptive cross-entropy.

10. The system of claim 1, wherein the TEF implements martingale-based drift detection using one or more learned martingales for causal diagnosis.

11. The system of claim 1, wherein the ESIM implements adaptive thresholding in which the adaptive threshold condition is defined using a rolling-window mean and standard deviation of an entropy metric.

12. The system of claim 1, wherein Entropy Injection Signatures (EIS) are classified into sub-categories comprising: EIS-SOURCE, EIS-DIST, EIS-COORD, EIS-PARAM, and EIS-COT.

13. The system of claim 1, further configured to map one or more EIS alerts to one or more semantic deviation categories including Predictive Signals (PS), Cross-Contextual Signatures (CCS), Mandela-Class Deviations (MCD), and Latent Collapse Signatures (LCS) for downstream analytics.

14. The system of claim 1, configured to integrate with a semantic deviation detection system by passing EIS alerts to a Deviation Interpretation Module (DIM) for unified analysis.

15. The system of claim 1, wherein the system is configured to provide low latency overhead per sampling event through vectorized operations, incremental computation, parallel module execution, and threshold-based early exit.

16. The system of claim 1, further comprising a chain-of-thought manipulation monitor (CTM) configured to detect inconsistencies in reasoning pathway sampling, wherein the CTM operates in a black-box compatible mode when internal model states are not accessible.

17. The system of claim 1, further comprising a sampling parameter integrity module (SPI) configured to detect unauthorized changes to sampling parameters comprising temperature, top-k, top-p, and seed values, and further configured to cause TEF to store, in the tamper-evident audit trail for a sampling event, at least: (i) an entropy-source identifier and RNG provider identifier; (ii) a representation of RNG state or seed material and one or more random draws used for token selection as permitted by policy; and (iii) a cryptographic binding between a selected token identifier and the corresponding entropy event record to enable replay verification and tamper detection.

18. The system of claim 1, further comprising an attribution and provenance layer (APL) configured to correlate detected EIS patterns with threat actor signatures.

19. The system of claim 1, wherein the ESIM validates entropy quality against a statistical test battery comprising frequency tests, runs tests, serial correlation tests, and autocorrelation tests.

20. The system of claim 1, further configured to operate in a fail-closed mode wherein the system blocks or restricts sampling when entropy integrity cannot be verified with sufficient confidence, and optionally executes entropy reseeding and/or entropy source switching until entropy integrity can be verified.

21. The system of claim 6, wherein the intent classification layer classifies an anomaly as (i) adversarial entropy manipulation, (ii) benign stochastic deviation, or (iii) entropy-source degradation, and selects a policy-gated response based on the classification.

22. The system of claim 17, wherein the entropy event record further comprises (i) an entropy-source identifier, (ii) an RNG state and/or seed value, (iii) one or more random draws and/or RNG outputs used in the token selection step, (iv) sampling parameters comprising at least temperature, top-k, and top-p, (v) a digest of a pre-sampling token probability distribution or sampling-candidate set, (vi) an identifier of the selected token, and (vii) a cryptographic commitment token that binds the selected token identifier to the entropy event record and to a hash-chain state, thereby enabling replay verification and tamper detection without revealing prompt content.

23. The system of claim 1, wherein the policy-gated corrective action comprises entropy source switching and/or entropy blending, wherein switching comprises transitioning from a first entropy source to a second entropy source upon satisfaction of an entropy anomaly condition, and wherein blending comprises combining multiple entropy sources with dynamically adjusted weights.

24. The system of claim 22, wherein the cryptographic commitment binds (i) one or more entropy events and (ii) one or more selected tokens into a tamper-evident chain such that a third party can verify integrity of the sampling decisions without access to internal model parameters, including model weights.
